(19) United States
(12) Patent Application Publication
(10) Pub. No.: US 2004/0035449 A1
(43) Pub. Date: Feb. 26, 2004

(54) Wet cleaning facility having bubble-detecting device

(76) Inventor: Ju-Hyun Nam, Suwon-City (KR)

Correspondence Address: VOLENTINE FRANCOS, P.L.L.C., Suite 150, 12200 Sunrise Valley Drive, Reston, VA, 20191, US

(21) Appl. No.: 10/620,708

(22) Filed: Jul. 17, 2003

(30) Foreign Application Priority Data
Aug. 20, 2002 (KR) 2002-49320

(51) Int. Cl. B08B 3/00

(52) U.S. Cl. 134/56 R; 134/78; 134/95.2; 134/108; 134/111; 134/113; 134/137

(57) ABSTRACT

A wet cleaning or wet etch facility for semiconductor wafers includes a plurality of chemical baths into which wafers are dipped, a drying unit for drying the wafers, a robot arm that transports the wafers to the plurality of the chemical baths and the drying unit in sequence, and a bubble-detecting sensor for detecting the amount of bubbles generated by the chemicals. A central control unit stops the wet cleaning or wet etch process for a while when the amount of bubbles produced by the chemical exceeds a predetermined amount.

### BACKGROUND OF THE INVENTION

1. Field of the Invention

The present invention relates to a wet cleaning facility for etching or cleaning a semiconductor wafer with chemicals. More particular, the present invention relates to a wet cleaning facility having a device for detecting bubbles in a chemical bath used to clean or etch a semiconductor wafer.

2. Description of the Related Art

Recently, as semiconductor devices become more highly integrated, the yield of the semiconductor manufacturing process has become more affected by impurities on the surface of the semiconductor wafer. Thus, the overall semiconductor device manufacturing process must include a cleaning process that removes particles and contaminants from the surface from the wafer.

Typical semiconductor wafer cleaning processes include wet cleaning processes in which the wafer is cleaned by chemicals, deionized water, and the like, and dry cleaning processes in which a wafer is mainly cleaned by plasma and inactive gas. The dry cleaning process is only capable of removing organic material and metallic material from the surface of the wafer. Accordingly, the overall semiconductor device manufacturing process generally must always include a wet cleaning process. The wet cleaning process entails dipping a number of wafers to be cleaned into a chemical bath a desired number of times for certain periods of time. As a result, the wafers are cleaned and contaminants and particles on the wafers are removed by a chemical reaction between the chemicals and the wafer.

However, a large number of bubbles is generated in the chemicals while the wet cleaning process is performed. The bubbles attach to the surface of the wafer and thus, form a film that isolates the wafer from the chemicals, i.e., prevents the chemical reaction between the chemical and the wafer. Therefore, the wafer can not be cleaned satisfactorily. Consequently, a large number of defective chips are formed from the wafer. That is, the bubbles lower the yield of the semiconductor devices that can be produced from the wafer.

Also, any bubble is not fixed at the original location on the wafer where it was produced. In fact, the bubbles move along the surface of the wafer due to the buoyancy of the bubbles in the chemical. Accordingly, this phenomenon exacerbates the problems produced by the bubbles.

### SUMMARY OF THE INVENTION

Accordingly, an object of the present invention is to solve the above-described problems of the prior art wet cleaning or wet etch facility. More specifically, an object of the present invention is to provide a facility that c an detect the amount of bubbles produced when a wafer is etched or cleaned by the chemicals.

According to the present invention, the facility comprises at least one chemical bath including a vessel having an open top, and a respective chemical contained in the vessel, a drying unit disposed downstream of the chemical bath(s), a robot arm having a working envelope encompassing the chemical baths and the drying unit fro transporting wafers to the chemical bath(s) and to the drying unit in sequence, a bubble-detecting sensor for sensing the amount of bubbles produced in the chemical of each bath and operative to generate signals indicative of the amount of bubbles; and a controller to which the bubble-detecting sensor is operatively connected.

According to one aspect of the present invention, a bubble-detecting sensor is operatively associated with each chemical bath so as to sense the amount of bubbles produced in the chemical of the bath.

According to another aspect of the present invention, each chemical bath comprises an internal chemical tank that contains the chemical, and an external chemical tank positioned relative to the internal chemical tank so as to receive chemicals that overflow out of the internal chemical tank. A chemical circulating line extends from a bottom portion of the external chemical tank to an upper portion of the internal chemical tank. A bubble-detecting sensor is operatively associated with the chemical circulating line so as to sense the amount of bubbles entrained in the chemical within the chemical circulating line.

The bubble-detecting sensor may comprise a vibrational detector for detecting the vibrations of the chemical bath as an indicator of the amount of bubbles therein, an optical sensor for sensing the color of the chemical as an indicator of the amount of bubbles therein, or a photo sensor for sensing the amount of light that may be transmitted along a path through the chemical as an indicator of the amount of bubbles therein.

If the amount of bubbles produced by the chemical as a result of the etching or cleaning process exceeds a reference value, the etching process or the cleaning process is stopped for a while. Accordingly, defects caused by the bubbles are minimized.

### BRIEF DESCRIPTION OF THE DRAWINGS

These and other objects, features and advantages of the present invention will become better understood from the following detailed description thereof made in conjunction with the accompanying drawings, in which like reference numerals designate like elements, and in which:

FIG. 1 is a schematic diagram of a first embodiment of a wet cleaning facility according to the present invention;

FIG. 2 is a schematic diagram of a bubble-detecting device and first chemical bath of the wet cleaning facility shown in FIG. 1;

FIG. 3 is a schematic diagram of a second embodiment of a wet cleaning facility according to the present invention; and

FIG. 4 illustrates portion A of the wet cleaning facility shown in FIG. 3.

### DETAILED DESCRIPTION OF PREFERRED EMBODIMENTS

A wet cleaning facility 100 equipped with a bubble-detecting sensor according to the present invention will now be described with reference to the accompanying drawings.

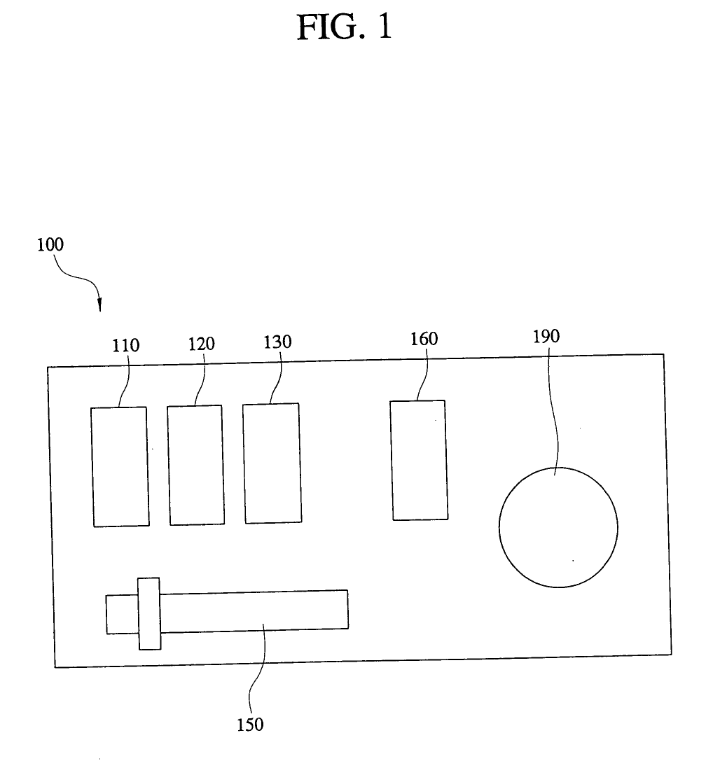

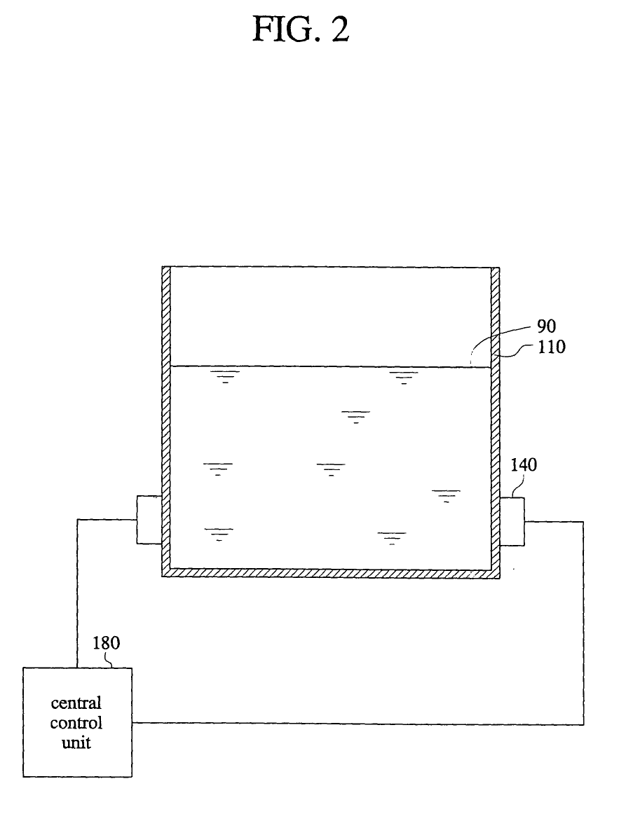

First, referring to FIG. 1 and FIG. 2, the wet cleaning facility 100 comprises a plurality of chemical baths 110, 120 and 130 into which the wafers are dipped in sequence so that all of the contaminants produced on the wafer during the semiconductor fabricating processes are removed, a final rinse bath 160 for finally rinsing the wafers cleaned at the chemical baths 110, 120 and 130, a drying unit 190 for drying the cleaned wafers, a robot arm 150 for moving the wafers throughout the wet cleaning facility, and a central control unit 180 for controlling the wet cleaning facility.

The number of the chemical baths as well as the type of chemicals 90 contained in the vessels of the chemical baths 110, 120 and 130 are selected according to the type of contaminants produced during the semiconductor fabricating process. According to an embodiment of the present invention, three chemical baths 110, 120 and 130 are provided. The chemicals 90 of the baths 110, 120 and 130 may respectively comprise a mixture of ammonia, hydrogen peroxide and water in a ratio of 1:1:5 to remove particles and organic materials, a mixture of hydrochloric acid, hydrogen peroxide and water in a ratio of 1:1:5 to remove particles and metallic material, and a mixture of sulfuric acid and hydrogen peroxide to remove organic materials such as a photoresist and a surfactant. A plurality of the wafers are dipped at once into each of the chemicals 90 contained in the vessels of the chemical baths 110, 120 and 130, and then each of the baths is replenished with a new batch of the chemical 90.

A bubble-detecting sensor is installed at opposing sidewalls of the vessel of each of the chemical baths 110, 120 and 130. FIG. 2 shows the bubble-detecting sensor 140 installed on the vessel sidewalls of the first chemical bath 110. The bubble-detecting sensor 140 detects the amount of bubbles produced by the chemical contained in the chemical bath 110, and then sends data indicative thereof to the central control unit 180.

The bubble-detecting sensor 140 may comprise a vibrational detector that detects the extent to which the bubbles are moving through the chemical 90, i.e., the extent to which the chemical 90 is shaken by the bubbles. The vessels of the chemical baths 110, 120 and 130, though, may each be made of transparent material, namely, quartz. Accordingly, the bubble-detecting sensor may be an optical detector that detects the change in color of the chemical 90 according to the amount of bubbles entrained in the chemical 90, and the like. Alternatively, the bubble-detecting sensor 140 may comprise photo detector including a light-receiving part (photo receptor) and a lighting-transmitting part (photo transmitter) disposed across from one another. Accordingly, the photo detector detects the amount of light that the light-receiving part receives from the light-transmitting part, which amount changes according to the amount of bubbles in the chemical 90. In any of these cases, the detectors are known per se, and readily adaptable for use in the bubble-detecting sensor according to the present invention.

The rinse bath 160 employs deionized water or the like to rinse the wafers cleaned at the chemical baths 110, 120 and 130. The drying unit 190 dries the cleaned and rinsed wafers using a spinning technique or a Marangoni technique to prevent watermarks from being produced on the wafers.

Now, the operation the wet cleaning facility 100 according to the present invention will be described.

First, processed semiconductor wafers are loaded into a container (not shown). The loaded semiconductor wafers are introduced into the first chemical bath 110, the second chemical bath 120 and the third chemical bath 130 in sequence, and are then introduced into the final rinse bath 160 and the drying unit 190, by robot arm 150. The wafer cleaning process is thus completed.

During this time, the central control unit 180 determines the amount of bubbles produced at each of the chemical baths 110, 120 and 130 in response to signals output from the bubble-detecting sensors 140. The central control unit 180 stops the wafer cleaning process for a while when the amount of the bubbles is more than a predetermined reference value. In this case, the operator of the wet cleaning facility checks the chemical bath in which an excessive amount of bubbles is produced. The wet cleaning process is reinstituted once the problem is resolved so that defects or problems created by an excessive amount of bubbles are prevented.

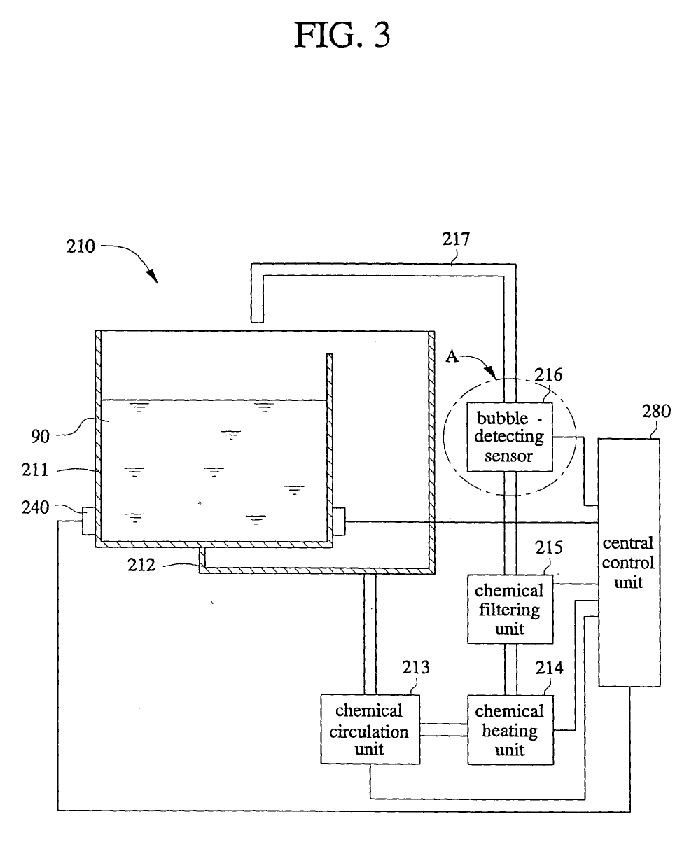

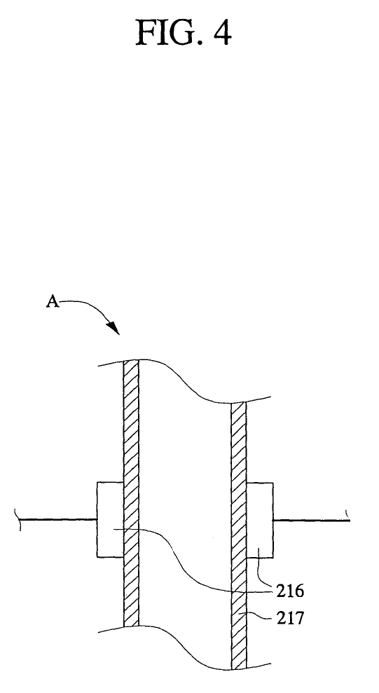

A second embodiment of a wet cleaning facility according to the present invention will now be described with reference to FIG. 3 and FIG. 4. Similar to the first embodiment, the second embodiment of the wet cleaning facility according to the present invention comprises a plurality of chemical baths 210 into which semiconductor wafers are dipped in sequence, a respective bubble-detecting sensor 240 which detects the amount of bubbles produced in the chemical contained in the vessel of each of the chemical baths 210, a final rinse bath for rinsing the wafers cleaned at the chemical baths 210, a drying unit for drying the cleaned and rinsed wafers, a robot arm for moving the wafers throughout the facility, and a central control unit 280 for controlling the wet cleaning facility.

In the first embodiment of the wet cleaning facility according to the present invention, only one batch of semiconductor wafers is dipped into the chemical 90 contained in the vessel of a chemical bath 110, 120 and 130 before the chemical 90 is replaced. On the other hand, in the second embodiment of the present invention, the chemical 90 contained in the vessel of a chemical bath 210 is used a predetermined number of times while being circulated before the chemical 90 is replaced with a new batch.

To this end, each chemical bath 210 of the second embodiment of the wet cleaning facility according to the present invention comprises an internal chemical tank 211, and an external chemical tank 212. A chemical circulating module through which the chemical 90 is circulated is attached each bath 210. The chemical 90 contained in the inner chemical tank 211 is allowed to overflow into the external chemical tank 212, and the chemical circulation module is connected to the bottom of the external chemical tank 212.

The chemical circulation module comprises a second bubble-detecting sensor 216 for detecting the amount of bubbles entrained in the circulating chemical 90. The chemical circulation module also comprises a chemical circulation unit 213 comprising a pump, a chemical heating unit 214 comprising a heater, a chemical filtering unit 215 comprising a filter, and a chemical circulation line 217. The chemical circulation module introduces the chemical 90 into the inner chemical tank 211 so that the chemical 90 overflows the inner chemical tank 211 into the external chemical tank 212, thereby circulating the chemical 90 through the inner chemical tank 211.

The chemical circulation unit 213, the chemical heating unit 214, the chemical filtering unit 215, and the bubble-detecting sensor 216 are installed in-line, i.e., on the chemical circulation line 217 extending from the bottom portion of the external chemical tank 212 to the upper portion of the inner chemical tank 211. At this time, the chemical circulation unit 213 pumps the chemical 90 through the chemical circulation line 217 so that the chemical 90 is circulated through the chemical bath 210. The chemical heating unit 214 heats the chemical 90 such that the chemical remains at a preferred temperature best-suited for the particular cleaning process. The chemical filtering unit 215 filters contaminants from the chemical 90.

The bubble-detecting sensor 216 may comprise a vibration detector that detects the extent to which the chemical 90 is vibrating due to the bubbles. In addition, the chemical circulation line 217 is preferably made of a transparent material. Therefore, the bubble-detecting sensor 216 may be an optical detector that detects the extent that the color of the chemical 90 is changed according to the amount of bubbles entrained in the chemical 90, and the like. Alternatively, the bubble-detecting sensor 216 may comprise a photo detector including a light-receiving part (photo receptor) and a lighting-transmitting part (photo transmitter) disposed across from one another on the chemical circulation line 217. Accordingly, the photo detector detects the amount of light that is transmitted from the light-transmitting part, which amount changes according to the amount of bubbles in the chemical 90 due to the tendency of the bubbles to scatter light.

The second embodiment of the wet cleaning facility according to the present invention also comprises a central control unit 280 that controls the wet cleaning facility in general. The central control unit 280 is connected to the chemical circulation unit 213, the chemical heating unit 214, the chemical filtering unit 215 and the bubble-detecting sensor 216 to control the units 213, 214 and 215, and the sensor 216, respectively. In particular, the bubble-detecting sensor 216 detects the amount of bubbles produced by the chemical 90 in the chemical bath 210. The central control unit 280 is configured to stop the circulation of the chemical 90 for a while if the amount of bubbles is more than a certain reference value.

Now, the operation and the effects of the second embodiment of the wet cleaning facility according to the present invention will be described.

First, processed semiconductor wafers are loaded into a container (not shown). The loaded semiconductor wafers are introduced by a robot arm into the inner chemical tanks 211 of chemical baths 210, e.g., first through third chemical baths 210, in sequence. The semiconductor wafers are then introduced by the robot arm into the final rinse bath and the drying unit.

During this time, the bubble-detecting sensor 240 installed on each of the chemical baths 210 senses the amount of bubbles in the chemical 90 contained in the inner chemical tank 211 of the bath 210. If the amount of bubbles is greater than the predetermined reference value, the central control unit 280 stops the wafer cleaning process for a while. In addition, the bubble-detecting sensor 216 detects the amount of bubbles entrained in the chemical 90 circulating through the circulation module, namely through the circulation line 217. The central control unit 280 controls the pump of the chemical circulation unit 213 to stop the flow of the chemical 90 thorough the circulation line 217 for a while if the amount of bubbles in the line 217 is greater than a predetermined reference value.

In either case, the operator of the wet cleaning facility checks the chemical bath 210 or the line 217 in which an excessive amount of bubbles is produced. The wet cleaning process is reinstituted once the problem is resolved so that defects or problems created by an excessive amount of bubbles are prevented.

As described above, the wet cleaning facility according to the present invention comprises a bubble-detecting sensor for detecting the amount of bubbles produced by the chemical being used to clean the wafers. The cleaning process is temporarily stopped if the amount of bubbles being during the wet cleaning process is excessive, i.e., more a certain reference value. Thus, the problems potentially caused by such bubbles are prevented.

Although the present invention has been particularly shown and described with reference to the preferred embodiments thereof, various changes in form and details, as will be apparent to those skilled in the art, may be made to the preferred embodiments without departing from the true spirit and scope of the invention as defined by the appended claims.

What is claimed is:

1. A wet cleaning or wet etch facility, comprising:
at least one chemical bath comprising a vessel having an open top, and a respective chemical contained in the vessel, whereby wafers can be dipped into the chemical contained in the vessel;
a drying unit disposed downstream of said at least one chemical bath in the facility and operable to dry wafers;
a robot arm having a working envelope encompassing said chemical baths and said drying unit so as to be operable to transport wafers to said at least one chemical bath and to said drying unit in sequence;
a bubble-detecting sensor operatively associated with each said at least one chemical bath so as to sense the amount of bubbles produced in the chemical of said bath and operative to generate signals indicative of said amount of bubbles; and
a controller to which said bubble-detecting sensor is operatively connected so as to receive said signals.

2. The facility according to claim 1, wherein said bubble-detecting sensor comprises a vibration sensor operative to generate a signal indicative of the amount said chemical is vibrating.

3. The facility according to claim 1, wherein said bubble-detecting sensor comprises an optical sensor operative to generate a signal indicative of the color of said chemical.

4. The facility according to claim 1, wherein said bubble-detecting sensor comprises a photo sensor having a light-transmitter and a light receptor.

5. The facility according to claim 1, wherein each said at least one chemical bath comprises an internal chemical tank that contains the chemical, and an external chemical tank positioned relative to said internal chemical tank so as to receive chemicals that overflow out of the internal chemical tank, and further comprising a chemical circulating line extending from a bottom portion of said external chemical tank to an upper portion of said internal chemical tank and through which the chemical is circulated from said external chemical tank back into said internal chemical tank, and a second bubble-detecting sensor operatively associated with said chemical circulating line so as to sense the amount of bubbles entrained in the chemical within said chemical circulating line and operative to generate signals indicative thereof, said controller being operatively connected to said second bubble-detecting so as to receive the signals generated thereby.

6. The facility according to claim 1, wherein each said at least one chemical bath comprises a vessel having transparent side walls.

7. The facility according to claim 5, wherein each said at least one chemical bath comprises a vessel having transparent side walls.

8. The facility according to claim 5, wherein said chemical circulating line is transparent.

9. The facility according to claim 7, wherein said chemical circulating line is transparent.

10. A wet cleaning or wet etch facility, comprising:
at least one chemical bath comprising an internal chemical tank, a respective chemical contained in the internal chemical tank, and an external chemical tank positioned relative to said internal chemical tank so as to receive chemicals that overflow out of the internal chemical tank, whereby a source of contamination can be removed by the chemical from the surface of a wafer by dipping the wafer into the chemical contained in the internal chemical tank;
a drying unit disposed downstream of said at least one chemical bath in the facility and operable to dry wafers;
a robot arm having a working envelope encompassing said chemical baths and said drying unit so as to be operable to transport wafers to said at least one chemical bath and to said drying unit in sequence;
a chemical circulating line extending from a bottom portion of said external chemical tank to an upper portion of said internal chemical tank and through which the chemical is circulated from said external chemical tank back into said internal chemical tank;
a bubble-detecting sensor operatively associated with said chemical circulating line so as to sense the amount of bubbles entrained in the chemical within said chemical circulating line and operative to generate signals indicative thereof; and
a controller operatively connected to said bubble-detecting sensor so as to receive said signals therefrom.

11. The facility according to claim 10, wherein said bubble-detecting sensor comprises a vibration sensor operative to generate a signal indicative of the amount said chemical is vibrating.

12. The facility according to claim 10, wherein said bubble-detecting sensor comprises an optical sensor operative to generate a signal indicative of the color of said chemical.

13. The facility according to claim 10, wherein said bubble-detecting sensor comprises a photo sensor having a light-transmitter and a light receptor.

14. The facility according to claim 10, wherein said chemical circulating line is transparent.
